(19) United States
(12) Patent Application Publication
(10) Pub. No.: US 2012/0296946 A1
(43) Pub. Date: Nov. 22, 2012

(54) FILE MANAGEMENT APPARATUS AND FILE MANAGEMENT APPARATUS CONTROLLING METHOD

(75) Inventor: Satoru GOTO, Nagoya-shi (JP)

(73) Assignee: Buffalo Inc., Nagoya-shi (JP)

(21) Appl. No.: 13/473,140

(22) Filed: May 16, 2012

(30) Foreign Application Priority Data
May 19, 2011 (JP) 2011-112922

(51) Int. Cl. G06F 17/30; G06F 15/16

(52) U.S. Cl. 707/827; 707/E17.01

(57) ABSTRACT

A file management apparatus that selects either synchronous upload or asynchronous upload as a method for uploading a file to an online storage, the selection based on at least one of an attribute of the file to be uploaded or a status of a communication channel between the file management apparatus and the online storage.

### CROSS-REFERENCE TO RELATED APPLICATION

This non-provisional application claims priority under 35 U.S.C. §119(a) to Japanese Patent Application No. 2011-112922 filed in Japan on May 19, 2011, the entire contents of which are hereby incorporated by reference.

### BACKGROUND OF THE DISCLOSURE

1. Field of the Disclosure

The present disclosure relates to a file management apparatus and a file management apparatus controlling method compatible with online storage services.

2. Description of the Related Art

There exist local storage arrangements such as storage devices incorporated in users' terminals (called the user terminal hereunder) and external storage devices to be connected to the user terminal, the devices being configured to store various files.

Progress in communication technology in recent years has given birth to online services (Web services) offering to store files in an online storage on the Internet. With such services, the user terminal uploads and downloads files to and from the online storage.

In order to enhance the availability of such online storage, there has been proposed a file management apparatus (see Japanese Patent Laid-open No. 2010-287104) offering an experience in which a user is led to utilize an online storage without becoming aware of it.

The file management apparatus proposed in the above-cited Japanese Patent Laid-open No. 2010-287104 includes an application for automatically uploading the files held and updated in the apparatus to an online storage. The proposed apparatus presents the user with a display of virtual files indicating as if the files are held inside the apparatus although they are actually in the online storage.

There may be conceived not one but a plurality of methods for uploading files to the online storage. Each of these methods has advantages and disadvantages.

In the related art, however, there is practically only one method adopted by each setup for making the upload to the online storage. The advantages of different upload methods have not been taken advantage of.

The present disclosure has been made in view of the above circumstances and provides a file management apparatus and a file management apparatus controlling method for permitting the selective use of a plurality of methods for making upload to an online storage.

### SUMMARY OF THE DISCLOSURE

According to an aspect of the present disclosure, there is provided a file management apparatus that selects either synchronous upload or asynchronous upload as a method for uploading a file to an online storage, the selection based on at least one of an attribute of the file to be uploaded or a status of a communication channel between the file management apparatus and the online storage.

### BRIEF DESCRIPTION OF THE DRAWINGS

Further objects and advantages of the present disclosure will become apparent upon a reading of the following description and appended drawings in which:

FIG. 1 is an overall configuration diagram of a communication system embodying the present disclosure;

FIG. 2 is a hardware configuration diagram of a NAS embodying the disclosure;

FIG. 3 is a functional block diagram of the NAS embodying the disclosure;

FIG. 4 is a schematic view showing a typical directory structure managed by a file management part embodying the disclosure;

FIG. 5 is a flowchart of typical operations constituting an upload method selection procedure embodying the disclosure;

FIG. 6 is an operating sequence diagram showing a successful synchronous upload embodying the disclosure;

FIG. 7 is an operating sequence diagram showing a failed synchronous upload embodying the disclosure; and

FIG. 8 is a flowchart of typical operations constituting an asynchronous upload embodying the disclosure.

### DESCRIPTION OF THE DISCLOSURE

A NAS (Network Attached Storage), for example, may serve as a file management apparatus embodying the present disclosure. Throughout the drawings referenced in the ensuing description, like or corresponding parts and components are designated by like or corresponding reference symbols.

### (System Configuration)

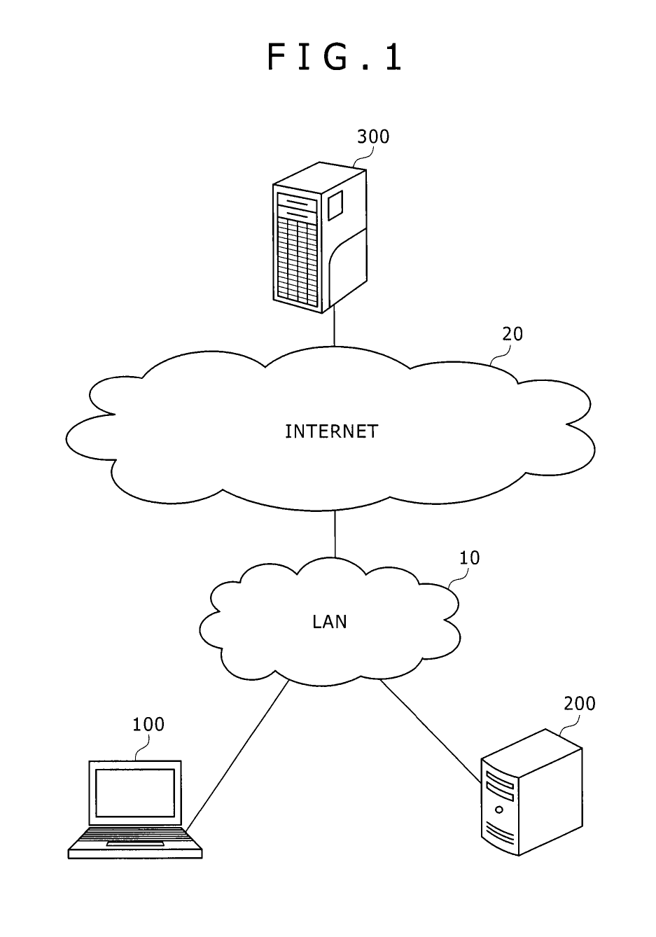

An overall configuration of a communication system 1 embodying the present disclosure will now be explained. FIG. 1 is an overall configuration diagram of the communication system 1.

As shown in FIG. 1, the communication system 1 embodying the present disclosure has a PC 100, a NAS 200, and an online storage 300. The PC 100, for example, may corresponds to a user terminal. However, the user terminal is not limited to the PC 100; the user terminal may also be a mobile phone terminal, a network-ready TV set or the like.

The PC 100 and NAS 200 are connected to a LAN (Local Area Network) 10 such as a home network, and can communicate with each other via the LAN 10. The LAN 10 is connected to the Internet 20 via a router or the like, not shown. The online storage 300 is connected to the Internet 20.

The PC 100 is a common information processing apparatus operated by a user and furnished with a program control device such as a CPU, a storage part such as a memory, a user interface including a display, a keyboard, a mouse, etc., and a network communication part for conducting network communications. The PC 100 stores and retrieves files to and from the NAS 200 via the LAN 10.

The NAS 200 is a file server customized to store and manage files. As such, the NAS 200 includes a program control device such as a CPU, a storage part such as a memory, a network communication part for conducting network communications, and a storage device. The CPU carries out processes (such as a process of a file system) for managing the files in the storage device. The NAS 200 may be shared by a plurality of user terminals.

The online storage 300 offers a Web service that stores and retrieves files, and is configured to include one or a plurality of file servers. For example, the online storage 300 offers a storage area that can be used by a user having registered with this Web service. In this regard, the user of the PC 100 is assumed to have registered with the service offered by the online storage 300.

The online storage 300 may be subject to use constraints imposed by the service provider. For example, the use constraints may include at least either an upper limit on the number of times access is made per unit time or an upper limit on the amount of data communicated per unit time.

In the current context, the unit time means, for example, a predetermined time period such as one minute or one hour. The upper limit on the number of times access is made per unit time is up to, say, 300 times in one hour for example. The upper limit on the amount of data communicated per unit time is up to, say, 1 TB per hour, for example. The number of times access is made to the online storage 300 corresponds to the number of times an API (Application Program Interface) of the online storage 300 is called.

### (NAS Configuration)

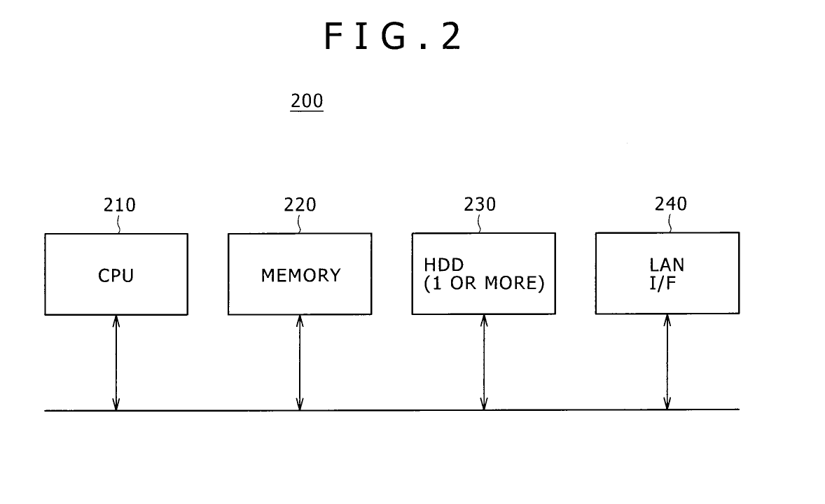

The hardware configuration of the NAS 200 is explained below. FIG. 2 is a block diagram showing a typical hardware configuration of the NAS 200.

As shown in FIG. 2, the NAS 200 has a CPU (Central Processing Unit) 210, a memory 220, one or a plurality of HDDs (Hard Disk Drives) 230, and a LAN interface 240. The CPU 210, memory 220, HDDs 230, and LAN interface 240 are interconnected via a bus line.

The CPU 210 executes control programs (firmware) that are stored in the memory 220. The CPU 210 performs at least upload to the online storage 300 or download from the online storage 300. The CPU 210 selects either synchronous upload or asynchronous upload as the method for uploading a file to the online storage 300, the selection being based on one or more conditions including at least an attribute of the file to be uploaded or status of a communication channel between the apparatus and the online storage 300. Using the upload method thus selected, the CPU 210 uploads the file to the online storage 300. Specific processing performed by the CPU 210 will be discussed later in detail.

The memory 220 is a flash memory, a RAM (Random Access Memory) or the like. The memory 220 stores the control programs to be executed by the CPU 210. Also, the memory 220 is used by the CPU 210 as a work area.

The memory 220 includes a cache area for temporarily storing the files to be uploaded to and downloaded from the online storage 300.

The HDDs 230 store diverse files. The HDDs 230 may be configured to make up a disk array or a RAID (Redundant Arrays of Inexpensive Disks).

The LAN interface 240 is connected to the LAN 10 and configured to conduct communications via the LAN 10. The LAN interface 240 may be connected to the LAN 10 in either wired or wireless fashion. The LAN interface 240 receives from the PC 100 a storage target file, a file storage request, a file update request, and a file read request, among others. The LAN interface 240 corresponds to a reception part for receiving files transmitted from the user terminal (PC 100) via the network (LAN 10).

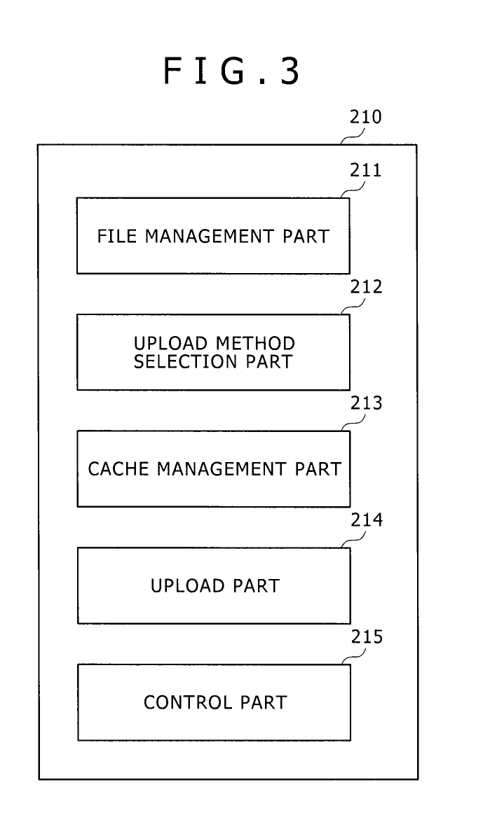

The operations of the NAS 200 are explained below. FIG. 3 is a functional block diagram of a typical NAS 200.

As shown in FIG. 3, the CPU 210 carries out the control programs held in the memory 220 to implement such functions as a file management part 211, an upload method selection part 212, a cache management part 213, an upload part 214, and a control part 215.

The file management part 211 carries out the processing of the file system. The file management part 211 performs file management using a directory structure in which virtual local directories representative of the online storage 300 are provided as part of the directories formed on the HDD 230 of the NAS 200. The organization of such virtual local directories may be implemented using FUSE (Filesystem in Userspace), NFS (Network File System) or the like. By accessing the NAS 200, the user of the PC 100 can view the directory structure including the virtual local directories and can handle files in the directories. A typical directory structure will be discussed later.

In this example, the substance of the files managed in the virtual local directories is located in the online storage 300. Thus, if there is a file storage request to store a file into a virtual local directory, it is necessary to upload the storage target file to the online storage 300 as described later. The ensuing paragraphs describe the operations for uploading a storage target file to the online storage 300 in response to a file storage request to store the file in question to the virtual local directory.

The upload method selection part 212 selects either synchronous upload or asynchronous upload as the method for uploading the target file to be stored (storage target file) to the online storage 300, the selection being based on at least either an attribute of the storage target file or status of a communication channel between the apparatus and the online storage 300. In this context, synchronous upload is an upload method that gives a display indicating that the file is being stored during the upload, and a display saying that the storage of the file has failed when the upload is unsuccessful. By contrast, Asynchronous upload is an upload method that gives neither the display indicating that the file is being stored during the upload, nor the display saying that the storage of the file has failed when the upload is unsuccessful.

The cache management part 213 stores (i.e., caches) into the cache area of the memory 220 the storage target file. Also, in response to a file update request from the PC 100, the cache management part 213 updates the file being cached in the cache area (i.e., overwrites the cached file with a new file).

In accordance with the upload method selected by the upload method selection part 212, the upload part 214 uploads to the online storage 300 the storage target file being stored in the cache area by the cache management part 213. It is assumed that the information necessary for the upload part 214 to upload files to the online storage 300 (e.g., address information, authentication information, etc.) is stored beforehand in the memory 220.

Also, where synchronous upload is selected for a given storage target file, the upload part 214 performs the upload in a manner synchronizing the target file stored in the cache area with the file stored in the online storage 300. That is, where synchronous upload is selected for a given file, every time the file in question is updated in the cache area, the updated file is uploaded to the online storage 300. This arrangement makes it possible for the upload part 214 to keep the file in the cache area identical with the corresponding file stored in the online storage 300.

Where asynchronous upload is selected for a given storage target file, the upload part 214 allows the storage target file in the cache area to become asynchronous with the file stored in the online storage 300. That is, where asynchronous upload is selected for a given file, even if the file in question in the cache area is updated, the updated file is not immediately uploaded to the online storage 300. This arrangement constitutes what is known as delay upload.

The control part 215 carries out control over synchronous upload and asynchronous upload.

Specifically, when synchronous upload is carried out, the control part 215 performs control to cause the PC 100 to give a continuous display indicating that the process of storing the file into the NAS 200 is underway until the upload to the online storage 300 is completed. That is, the control part 215 performs control not to notify the PC 100 that the process of storing the file into the NAS 200 is completed until receipt of notification from the online storage 300 that the upload thereto is completed. If notified of a failed upload from the online storage 300, the control part 215 notifies the PC 100 that the process of storing the file into the NAS 200 is unsuccessful.

Also, when asynchronous upload is carried out, the control part 215 performs control to put on hold the upload of the storage target file until a predetermined holding time (e.g., time-out time) elapses after the file in question is stored into the cache area by the cache management part 213, regardless of the cached target file being updated. The higher the frequency with which the storage target file being cached is updated, the longer the time can be in which the control part 215 puts the upload of the file in question on hold.

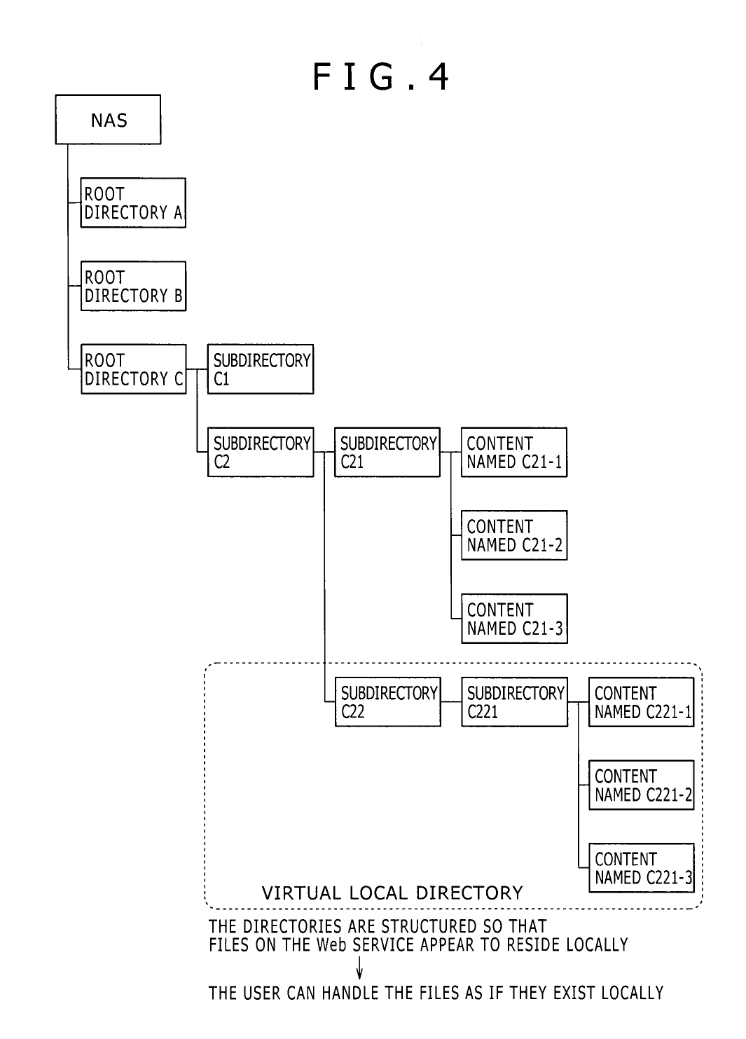

A specific example of the directory structure managed by the file management part 211 is explained below. FIG. 4 is a schematic view showing a typical directory structure managed by the file management part 211.

As one example, the directory structure shown in FIG. 4 has root directories A through C of which the substance is held on the HDD 230 in the NAS 200. Also, subdirectories C1 and C2 are formed under the root directory C, and subdirectories C21 and C22 are placed subordinate to the subdirectory C2.

The substance of the files included in the subdirectory C21 (contents C21-1 through C21-3) is stored in the NAS 200. By contrast, the substance of the files included in the subdirectory C22 (i.e., subdirectory C221; contents C221-1 through C221-3) in the subdirectory C2 is stored in the online storage 300.

As described above, although the directories subordinate to the subdirectory C22 are handled as if the files therein exist in the NAS 200, the substance of these files is in fact stored in the online storage 300. As such, these subdirectories are configured as virtual local directories.

The above-described virtual local directories may be configured using software such as FUSE (Filesystem in Userspace) with which the file system can be organized.

### (NAS Operations)

Explained below are the operations of the NAS 200 under three headings: (1) operations for selecting the upload method, (2) a specific example of synchronous upload, and (3) a specific example of asynchronous upload. The ensuing paragraphs describe the operations for uploading a storage target file to the online storage 300 in response to a file storage request to store the file in question to a virtual local directory.

### (1) Operations for Selecting the Upload Method

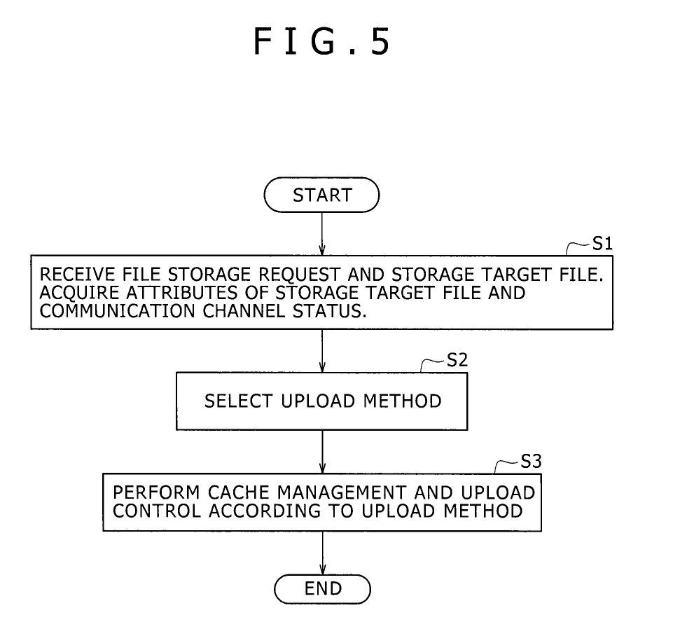

FIG. 5 is a flowchart of typical operations performed by the file management apparatus for selecting the upload method.

As shown in FIG. 5, in step S1, the LAN interface 240 receives a file storage request to store a file into a virtual local directory and the target file to be stored.

Based on information included in at least either the file storage request or the storage target file, the upload method selection part 212 acquires an attribute of the storage target file. In this case, the attribute of the storage target file may be the file type to be handled by the file system, a file name extension, a MIME type associating the extension with the file data type, or the size of the storage target file, for example.

Also, the upload method selection part 212 acquires information indicative of the status of the communication channel between the NAS 200 and the online storage 300. For example, the information indicative of the communication channel status between the NAS 200 and the online storage 300 may be composed of information indicating whether the NAS 200 is connected to the network in wired or wireless fashion, information indicating the transmission speeds reached between the NAS 200 and the online storage 300 (theoretical limits, or statistical values such as average, maximum and minimum speeds of past record values), or information including at least one of packet loss probabilities between the NAS 200 and the online storage 300. The transmission speeds and packet loss probabilities can be measured using ICMP (Internet Control Message Protocol), for example.

In step S2, based on at least either the attribute of the storage target file or the information indicating the communication channel status acquired in step S1, the upload method selection part 212 selects the upload method to be used for uploading the target file to be stored. There may be conceived a first through a fourth upload method to choose from, as will be explained below.

The first upload method is as follows: upon determining that the file size of the storage target file is relatively large, the upload method selection part 212 selects asynchronous upload as the method for uploading the target file to be stored. For example, the upload method selection part 212 determines that the file size of the storage target file is relatively large if the file type in effect is generally associated with a relatively large size or if the actual file size exceeds a predetermined file size threshold value. The file type may be determined based on the file name extension or MIME type, for example. The file type of which the file size is generally considered to be relatively large is a file containing video data, for example. If it is determined that the type of the storage target file denotes a file that contains video data, the upload method selection part 212 determines that the file size of the storage target file is relatively large.

The second upload method is as follows: upon determining that the file size of the storage target file is relatively small (i.e., the file size is not relatively large), the upload method selection part 212 selects synchronous upload as the method for uploading the file in question. For example, the upload method selection part 212 determines that the file size of the storage target file is relatively small if the file type in effect is generally associated with a relatively small size or if the actual file size does not exceed a predetermined file size threshold value. The file type may be determined based on the file name extension or MIME type, for example. The file type of which the file size is generally considered to be relatively small is a file of which the file type, file name extension, or MIME type denotes a file created using Microsoft Office application, for example.

The third upload method is as follows: the upload method selection part 212 determines whether the attribute of the storage target file requires that the upload of the file be reliable. Upon determining that the attribute of the storage target file requires that the file in question be uploaded in reliable fashion, the upload method selection part 212 selects synchronous upload as the method for uploading the storage target file. This determination can also be made based on the file type. For example, if the file type, file name extension, or MIME type of the storage target file indicates that the file in question is a photo (still picture) file, the upload method selection part 212 determines that the target file needs to be uploaded reliably. If it is determined that the storage target file is not required to be uploaded reliably, then the upload method selection part 212 selects asynchronous upload as the method for uploading the file in question.

The fourth upload method is as follows: the upload method selection part 212 may select the upload method based on the status of the communication channel between the apparatus and the online storage 300. Specifically, if it is determined that the reliability of communication between the NAS 200 and the online storage 300 is poor, the upload method selection part 212 selects synchronous upload as the method for uploading the storage target file. For example, if the NAS 200 is connected wirelessly to the Internet, if the actually measured transmission speed is low, or if the packet loss probability involved is high, then the upload method selection part 212 determines that the reliability of communication is low.

If it is determined that the reliability of communication between the NAS 200 and the online storage 300 is good, the upload method selection part 212 selects asynchronous upload as the method for uploading the storage target file.

The upload method selection part 212 may selectively use some of the above-described first through fourth methods in combination. In this case, the selected methods may be prioritized. If there is an inconsistency of results between the methods, the method with the highest priority may be adopted.

In step S3, under control of the control part 215, the cache management part 213 and upload part 214 perform cache management and upload control in accordance with the upload method selected by the upload method selection part 212. The manner in which cache management and upload control are performed varies depending on whether the upload method is synchronous upload or asynchronous upload. Explained below is what takes place for cache management and upload control in each of these two cases.

### (2) Specific Example of Synchronous Upload

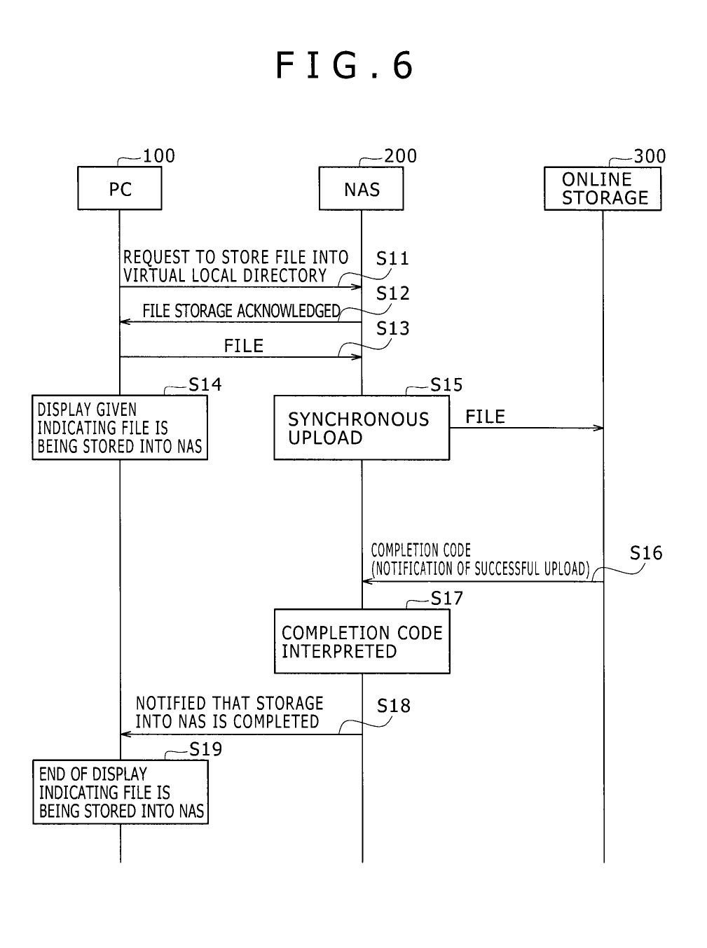

Specific operations for carrying out synchronous upload are explained below. FIG. 6 is an operating sequence diagram showing a successful synchronous upload.

As shown in FIG. 6, in step S11, the PC 100 transmits to the NAS 200 a file storage request to store a file into the virtual local directory described above in the directory structure managed by the NAS 200. The NAS 200 receives the file storage request. It is assumed here that the NAS 200 has chosen to perform synchronous upload following the above-described selection of the upload method.

In step S12, the NAS 200 sends an acknowledge signal in response to the file storage request. The PC 100 receives the acknowledge signal.

In step S13, the PC 100 starts transferring to the NAS 200 the storage target file corresponding to the file storage request.

In step S14, the PC 100 starts giving a display indicating that the file is being stored into the virtual local directory of the NAS 200.

In step S15, the NAS 200 performs synchronous upload of the storage target file transferred from the PC 100. More specifically, the NAS 200 uploads the storage target file to the online storage 300 in parallel with the process of caching the file in question. Every time the storage target file is updated, the NAS 200 uploads the updated file to the online storage 300.

The online storage 300 receives the storage target file and determines whether the file in question meets the constraints of the service. It is assumed here that the storage target file meets the service constraints.

In step S16, the online storage 300 transmits to the NAS 200 a completion code indicating that the storage of the target file is completed. The NAS 200 receives the completion code. The completion code indicating that the storage of the target file is completed means that the upload to the online storage 300 is normally finished (i.e., successful upload).

In step S17, upon receipt from the online storage 300 of the completion code saying that the upload thereto is completed, the NAS 200 issues a notification that the process of storing the file into the virtual local directory of the NAS 200 is completed.

In step S18, the NAS 200 transmits to the PC 100 a notification that the process of storing the target file into the virtual local directory of the NAS 200 is completed (i.e., storage complete response). The PC 100 receives the storage complete response.

As described, the NAS 200 does not notify the PC 100 that the process of storing the file into the NAS 200 is complete until receipt from the online storage 300 of the notification that the upload thereto is completed.

In step S19, upon receipt of the storage complete response from the NAS 200, the PC 100 stops giving the display saying that the storage target file is being stored into the virtual local directory of the NAS 200. While the storage target file is being stored into the NAS 200, the PC 100 performs control to inhibit any operations on the file in question residing on the PC 100.

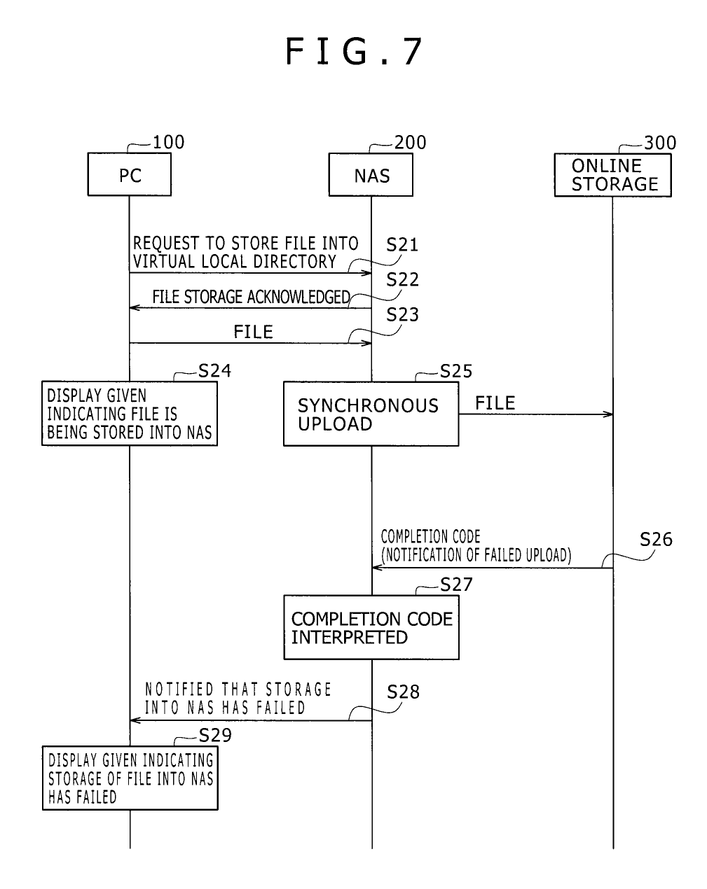

FIG. 7 is an operating sequence diagram showing a failed synchronous upload.

Steps S21 through S24 in FIG. 7 are substantially the same as the above-described steps S11 through S14 and thus will not be discussed further.

In step S25, the NAS 200 performs synchronous upload of the storage target file transferred from the PC 100. More specifically, the NAS 200 uploads the storage target file to the online storage 300 in parallel with the process of caching the file in question. Every time the storage target file is updated, the NAS 200 uploads the updated file to the online storage 300.

The online storage 300 receives the storage target file and determines whether the storage target file meets the constraints of the service. It is assumed here that the storage target file does not meet the service constraints.

In step S26, the online storage 300 transmits to the NAS 200 a completion code indicating that the storage of the target file is not completed. The NAS 200 receives the completion code. The completion code saying that the storage of the target file is not completed means that the upload to the online storage 300 has failed.

In step S27, upon receipt from the online storage 300 of the completion code indicating that the storage of the target file is not completed, the NAS 200 issues a notification that the process of storing the file in question into the virtual local directory of the NAS 200 has failed.

In step S28, the NAS 200 transmits to the PC 100 a notification that the process of storing the target file into the virtual local directory of the NAS 200 is unsuccessful (i.e., save failure response). The PC 100 receives the save failure response.

As described, upon receipt from the online storage 300 of the notification that the upload thereto has failed, the NAS 200 notifies the PC 100 that the process of storing the file into the NAS 200 is unsuccessful.

In step S29, upon receipt of the save failure response from the NAS 200, the PC 100 gives a display indicating that the storage of the target file into the virtual local directory of the NAS 200 has failed.

In the operating sequence shown in FIG. 7, the NAS 200 may retry the upload upon receipt of the completion code saying that the storage of the target file into the online storage 300 is unsuccessful. The retry helps improve the probability of a successful upload.

In the operating sequence shown in FIG. 6, upon receipt of the completion code indicating that the storage of the target file into the online storage 300 is successful, the NAS 200 may verify whether the upload has been done correctly. For example, the target file in the online storage 300 is compared with the corresponding file in the NAS 200 to see if the two files coincide with each other. Such verification helps improve the reliability of the upload.

### (3) Specific Example of Asynchronous Upload

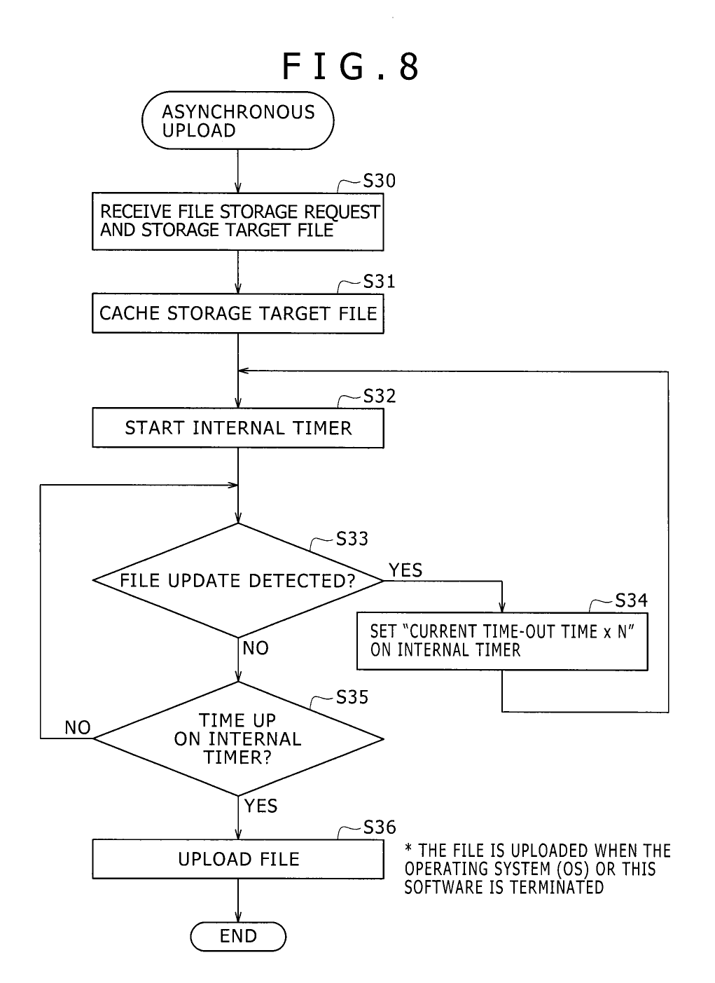

Specific operations for carrying out asynchronous upload are explained below. FIG. 8 is a flowchart of typical operations constituting asynchronous upload. The ensuing explanation will show how a file to be stored into a virtual local directory is typically uploaded asynchronously.

As shown in FIG. 8, in step S30, the LAN interface 240 first receives a file storage request to store a file into a virtual local directory, and later receives the storage target file. It is assumed here that the NAS 200 has chosen to perform asynchronous upload following the above-described selection of the upload method.

In step S31, in response to the file storage request to store the target file into the virtual local directory, the cache management part 213 stores (i.e., caches) the file in question into the cache area.

In step S32, the control part 215 sets an initial value of time-out time (e.g., 15 seconds) on an internal timer, and starts the internal timer.

In step S33, the control part 215 determines whether there is a file update request to update the file stored in the cache area by the cache management part 213. If it is determined that there is a file update request to update the file held in the cache area by the cache management part 213 (“YES” in step S33), the control part 215 goes to step S34. On the other hand, if it is determined that there is no such file update request to update the file held in the cache area by the cache management part 213 (“NO” in step S33), the control part 215 goes to step S35.

In step S34, the control part 215 resets the internal timer by prolonging the current time-out time. For example, the control part 215 may set the current time-out time multiplied by N (e.g., N=2) on the internal timer for reset. After resetting the internal timer, the control part 215 returns to step S32 and continues its processing. This starts the internal timer on which the prolonged (e.g., multiplied by N) time-out time is being set.

In step S35, on the other hand, the control part 215 determines whether time is up on the internal timer (i.e., whether a time-out has occurred). If it is determined that a time-out has occurred on the internal timer (“YES” in step S35), the control part 215 goes to step S36. If it is determined, on the other hand, that a time-out has yet to occur (“NO” in step S35), the control part 215 returns to step S33. In step S33, the control part 215 again determines whether there is a file update request.

In step S36, the control part 215 controls the upload part 214 to upload the file stored in the cache area by the cache management part 213.

In this example, the upload of the file is put on hold at least for a predetermined holding time. If an update of the target file is detected during the holding time, the upload of the file in question is further prolonged. For example, if the initial holding time is assumed to be 15 seconds and if the holding time is doubled every time the file is updated, the upload of the file is put on hold for a total of 30 seconds. That is, if the file is updated 10 seconds after the start of the holding time, the upload of the file is put on hold for another 20 seconds starting from the point of the update (for a total holding time of 30 seconds). If another update of the file being put on hold for 30 seconds is detected, the upload of the file in question is placed on hold for a total of 60 seconds. Thus, the higher the frequency with which the file is updated, the longer the time can be in which to put the upload of the file in question on hold.

The holding time may be varied by those skilled in the art using other methods. For example, the prolongation of the holding time may be determined based on the remaining holding time. If the prolongation is to be twice the remaining holding time and if an update is made 10 seconds after the start of a 15-second holding time, then the prolongation will be 10 seconds, i.e., twice the remaining 5 seconds so that the file is put on hold for a total of 20 seconds.

If an instruction is issued to interrupt or terminate the ongoing process shown in FIG. 8, entailing a shutdown of the file management apparatus, for example, then the control part 215 goes to step S36 and performs the upload even if a time-out has yet to occur on the internal timer.

As explained above, the NAS 200 selects either synchronous upload or asynchronous upload as the method for uploading the target file to the online storage 300, the selection being based on at least either the attribute of the file in question or the status of the communication channel between the NAS 200 and the online storage 300. In this manner, the NAS 200 selectively determines the method used for making the upload to the online storage 300 according to the circumstances.

Synchronous upload has an advantage of displaying the status of an upload being made. This feature helps improve the reliability of the upload. However, synchronous upload has a disadvantage of entailing a binding time in which any operations on the file being uploaded are inhibited as long as the status of the currently uploaded file is displayed. By contrast, asynchronous upload has a disadvantage of entailing reduced reliability of the upload because upload status is not displayed. However, asynchronous upload has an advantage of not being subject to any binding time. Synchronous upload or asynchronous upload is selectively used for each file so that the advantages of the two types of upload can be made the most of.

Synchronous upload has another advantage of improving the reliability of the upload because this is a method for synchronizing the file cached in the NAS 200 with the corresponding file stored in the online storage 300. However, synchronous upload has another disadvantage of increased traffic load due to the high frequency of making the upload. Meanwhile, asynchronous upload is an upload method that allows the file cached in the NAS 200 to be asynchronous with the corresponding file stored in the online storage 300. For that reason, asynchronous upload has the disadvantage of low reliability in terms of making the upload but offers an advantage of reduced traffic load. Synchronous upload or asynchronous upload is thus used selectively for each file so that the advantages of both types of upload can be made the most of.

If it is determined that the attribute of the file to be uploaded denotes a relatively large file size, the NAS 200 selects asynchronous upload as the method for uploading the file in question. Synchronous upload, if selected for a large-sized file, would prolong the binding time involved. In this case, asynchronous upload is selected to make the most of its advantages.

If it is determined that the attribute of the file to be uploaded denotes a relatively small file size, the NAS 200 selects synchronous upload as the method for uploading the file in question. In the case of a small-sized file, synchronous upload may be selected as the method for uploading the file and the binding time involved can still be short. For small-sized files, synchronous upload is thus selected as the upload method of which the advantage of the increased reliability of upload is made the most of.

If it is determined that the attribute of the file to be uploaded requires that the upload be reliable, the NAS 200 selects synchronous upload as the method for uploading the file in question. Where synchronous upload is selected for files that need to be uploaded reliably, the binding time involved is generally short. For these files, synchronous upload is selected as the upload method of which the advantages are made the most of.

If it is determined that the status of the communication channel between the apparatus and the online storage 300 is not highly reliable, the NAS 200 selects synchronous upload as the method for uploading the target file. Where the status of the communication channel between the apparatus and the online storage 300 is not very reliable, it is preferred that the user should get hold of upload status. In such a case, synchronous upload is selected as the upload method of which the advantages are made the most of.

The NAS 200 performs file management using a directory structure in which virtual local directories whose substance is located in the online storage 300 are placed subordinate to a directory in the NAS 200. And the NAS 200 selects either synchronous upload or asynchronous upload as the method for uploading the target file to be stored into a virtual local directory. This arrangement allows the directory structure to be changed so that the online storage 300 may be handled as a local storage and that the appropriate upload method may be selected for the target file to be stored into the virtual local directory.

### (Modifications)

Although the description made above in reference to the accompanying drawings contains many specificities, these should not be construed as limiting the scope of the disclosure but as merely providing illustrations of the present disclosure. It is evident that many alternatives, modifications and variations will become apparent to those skilled in the art in light of the foregoing description.

For example, whereas the NAS 200 has been described as the file management apparatus embodying the present disclosure, the PC 100 may be considered alternatively to be the file management apparatus replacing the NAS 200. In this case, the disclosure may be implemented as a backup feature for the PC 100. Furthermore, the file management apparatus is not limited to the PC 100. The file management apparatus embodying this disclosure may also be implemented in the form of a cellular communication apparatus or a wireless LAN apparatus, among others.

Thus, the scope of this disclosure should be determined by the appended claims and their legal equivalents, rather than by the examples given.

What is claimed is:

1. A file management apparatus comprising:
a processor that selects either synchronous upload or asynchronous upload as a method for uploading a file to an online storage, said selection based on at least one of an attribute of said file to be uploaded or a status of a communication channel between said file management apparatus and said online storage.

2. The file management apparatus according to claim 1, wherein
said processor controls displaying an indication that said file is being stored during upload of said file and that storage of said file has failed when the upload of said file is unsuccessful when said synchronous upload is selected.

3. The file management apparatus according to claim 1, wherein
said processor controls displaying an indication that said file is being stored during upload of said file and not displaying and indication that the storage of said file has failed when upload of said file is unsuccessful when said asynchronous upload is selected.

4. The file management apparatus according to claim 1, wherein
said processor:
controls storing said file to be uploaded into a cache area;
updates said file stored in said cache area in response to a request; and
controls uploading said file stored in said cache area to said online storage using said method for uploading a file selected by said upload method selection part, wherein
said synchronous upload is a method for making said upload in a manner synchronizing said file stored in said cache area with said file to be stored into said online storage, and
said asynchronous upload is a method for making the upload in a manner allowing said file stored in said cache area to be asynchronous with said file to be stored into said online storage.

5. The file management apparatus according to claim 1, wherein said processor selects said asynchronous upload as the method for uploading said file if said attribute of said file to be uploaded indicates a large file size.

6. The file management apparatus according to claim 1, wherein said processor selects said synchronous upload as the method for uploading said file if an attribute of said file to be uploaded indicates a small file size.

7. The file management apparatus according to claim 1, wherein said processor selects said synchronous upload as the method for uploading said file if an attribute of said file to be uploaded is determined to require that said file be uploaded reliably.

8. The file management apparatus according to claim 1, wherein said processor selects said synchronous upload as the method for uploading said file if a status of a communication channel between the file management apparatus and said online storage is determined to indicate a low reliability of communication.

9. The file management apparatus according to claim 1, further comprising:
a network interface that receives a file transmitted from a user terminal via a network, wherein
said processor selects either said synchronous upload or said asynchronous upload as the method for uploading said file received by said network interface.

10. The file management apparatus according to claim 1, wherein
the processor performs file management using a directory structure in which a virtual local directory of which the substance is located in said online storage is placed subordinate to a directory of which the substance is located in said file management apparatus, and
said processor selects either said synchronous upload or said asynchronous upload as the method for uploading the file to be stored into said virtual local directory.

11. A file management method performed by a file management apparatus, the method comprising:
selecting, by a processor of the file management apparatus, either synchronous upload or asynchronous upload as a method for uploading a file to an online storage, the selection being based on at least one of an attribute of said file to be uploaded and a status of a communication channel between the apparatus and said online storage.

12. A computer-readable medium including computer program instructions, which when executed by a computer, cause the computer to perform a method comprising:
selecting either synchronous upload or asynchronous upload as a method for uploading a file to an online storage, the selection being based on at least one of an attribute of said file to be uploaded and a status of a communication channel between the apparatus and said online storage.
